(19) United States
(12) Patent Application Publication
(10) Pub. No.: US 2011/0157561 A1
(43) Pub. Date: Jun. 30, 2011

(54) PROJECTOR

(75) Inventors: Yi-Kuan Liao, Hsinchu (TW); Yung-Lung Lin, Hsinchu (TW)

(73) Assignee: YOUNG GREEN ENERGY CO., Hsinchu County (TW)

(21) Appl. No.: 12/821,694

(22) Filed: Jun. 23, 2010

(30) Foreign Application Priority Data
Dec. 30, 2009 (CN) 200910263729.7

(51) Int. Cl. G03B 21/16

(52) U.S. Cl. 353/61

(57) ABSTRACT

A projector includes a light source, a fan and a guiding passage. The fan is disposed beside a first side of the light source. The guiding passage has a guiding inlet and a guiding outlet. The guiding passage extends from a section near the fan to a section near a second side of the light source. The fan is capable of generating a first airflow and a second airflow. The first airflow is capable of being mixed with the second airflow near the second side of the light source. The second airflow is guided by the guiding passage so that the second airflow is mixed with the first airflow near the second side of the light source.

### CROSS-REFERENCE TO RELATED APPLICATION

This application claims the priority benefit of China application serial no. 200910263729.7, filed on Dec. 30, 2009. The entirety of the above-mentioned patent application is incorporated herein by reference and made a part of this specification.

### BACKGROUND

1. Field of the Invention

The invention relates to a projector, and more particularly, to a projector having a guiding passage.

2. Description of Related Art

FIG. 1A is a schematic view of a traditional projector. FIG. 1B is a cross-sectional schematic view of the projector of FIG. 1A taken along the line I-I′. It should be noted that for the convenience of description, a top portion of a housing is not shown in FIG. 1A. Referring to FIGS. 1A and 1B, a traditional projector 100 includes a housing 110, a light source 120, an imaging system 130, an optical system 140 and a fan 150. The housing 110 has a main air outlet 112 and a main air inlet 114. The light source 120 is disposed in the housing 110 and located beside the main air outlet 112. The light source 120 includes a reflector 122 and a lampwick 124 disposed in the reflector 122. The lampwick 124 is capable of generating an illumination light beam. The fan 150 is located beside the light source 120 such that the light source 120 is located between the fan 150 and the main air outlet 112.

The optical system 140 is disposed in the housing 110 and located in a transmission path of the illumination light beam. The optical system 140 is capable of converting the illumination light beam into an image light beam. The imaging system 130 is partially disposed in the housing 110 and located in a transmission path of the image light beam. The imaging system 130 includes a projection lens 132 which can project the image light beam onto a screen (not shown).

When the projector 100 operates, the fan 150 generates an airflow A1. The airflow A1 flows to the outside of the housing 110 through the reflector 122 of the light source 120 and the main air outlet 112 of the housing 110. Therefore, the airflow A1 can transmit the waste heat generated by the lampwick 124 of the light source 120 to the outside of the housing 110. However, because the temperature of a part A11 of the airflow A1 flowing through a section near the lampwick 124 is relatively high, the temperature of another part A12 of the airflow A1 flowing through other parts of the light source 120 is relatively low and the mixture efficiency of two parts A11 and A12 of the airflow A1 is poor, the temperature of a partial section Z1 of the main air outlet 112 is relatively higher than the temperature of the design requirement.

In order to solve the above problems, another traditional projector is provided. FIG. 2A is a schematic view of another traditional projector. FIG. 2B is a cross-sectional schematic view of the projector of FIG. 2A taken along the line J-J′. It should be noted that for the convenience of description, a top portion of a housing is not shown in FIG. 2A. Referring to FIGS. 2A and 2B, in a projector 200, a plurality of guiding plates 260 are disposed in the housing 210 and located between a main air outlet 212 and a light source 220. When the projector 200 operates, a part A21 of an airflow A2 flowing through a section near a lampwick 224 is forcibly mixed with another part A22 of the airflow A2 flowing through other parts of the light source 220 because of the influence of the guiding plates 260 such that the temperature of the mixed airflow A2 is decreased. However, the effect of flow resistance generated by the guiding plates 260 may reduce the flow amount of the airflow A2 flowing through the main air outlet 212 so that the waste heat generated by the lampwick 224 cannot be effectively transmitted out of the housing 210. Thus, the temperature near the lampwick 224 is still too high.

### BRIEF SUMMARY

The invention provides a projector having a guiding passage configured to guide an airflow.

Other advantages and objects of the invention may be further comprehended through the technical features disclosed in the invention.

To achieve one of or part of or all of above objectives or other objectives, the invention provides a projector including a light source, a fan and a guiding passage. The fan is adjacently disposed beside a first side of the light source. The guiding passage has a guiding inlet and a guiding outlet. The guiding inlet is adjacently disposed beside the fan and the guiding outlet is adjacently disposed beside a second side of the light source. The guiding passage extends from a section near the fan to a section near the second side of the light source such that the light source is located between the fan and the guiding outlet.

The fan is capable of generating a first airflow and a second airflow, the first airflow is capable of flowing through the light source and the second airflow is capable of flowing through the guiding passage. The second airflow in the guiding passage is spatially spaced apart from the first airflow and the first airflow is capable of being mixed with the second airflow near the second side of the light source.

In one embodiment of the invention, the guiding passage further comprises a first guiding path and a second guiding path. The guiding inlet is disposed on one end of the first guiding path. The first guiding path extends beside the light source. The second guiding path connects with the first guiding path and the guiding outlet is disposed on one end of the second guiding path.

In one embodiment of the invention, the projector further comprises a housing. The light source, the fan and the guiding passage are disposed in the housing and the first guiding path is located between the housing and the light source.

In one embodiment of the invention, the second guiding path is a tube-shaped body.

In one embodiment of the invention, a flowing direction of the second airflow near the guiding outlet is substantially perpendicular or parallel to a flowing direction of the first airflow.

In one embodiment of the invention, the guiding passage is composed of a material with a thermal conductivity coefficient less than 20 W/mk.

In one embodiment of the invention, an optical axis of the light source is substantially perpendicular to a flowing direction of the first airflow and a flowing direction of the second airflow.

The second airflow is guided by the guiding passage to be mixed with the first airflow near the second side of the light source. Therefore, when the projector of the invention operates, the mixture efficiency of the first airflow and the second airflow is better than traditional projectors.

### BRIEF DESCRIPTION OF THE DRAWINGS

The accompanying drawings are included to provide a further understanding of the embodiments of the invention, and are incorporated in and constitute part of this specification. The drawings illustrate embodiments of the invention and, together with the description, serve to explain the principles of the invention.

FIG. 1A is a schematic view of a traditional projector.

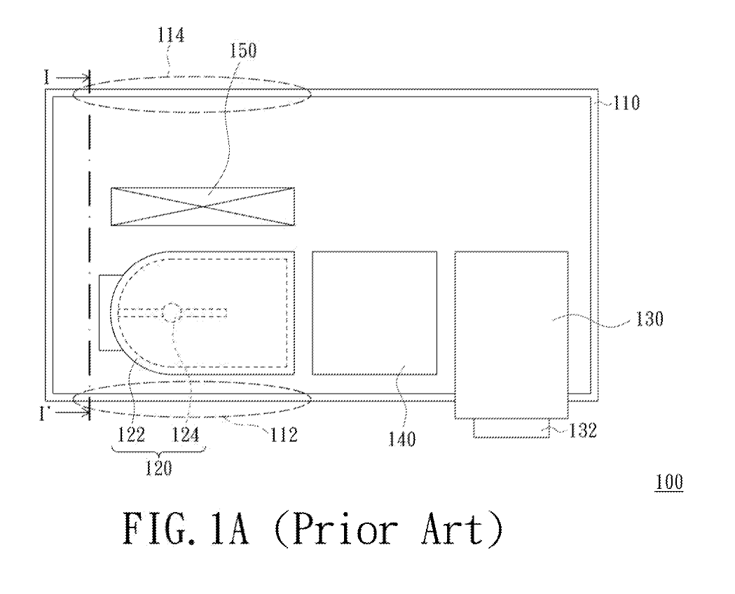

FIG. 1B is a cross-sectional schematic view of the projector of FIG. 1A taken along the line I-I′.

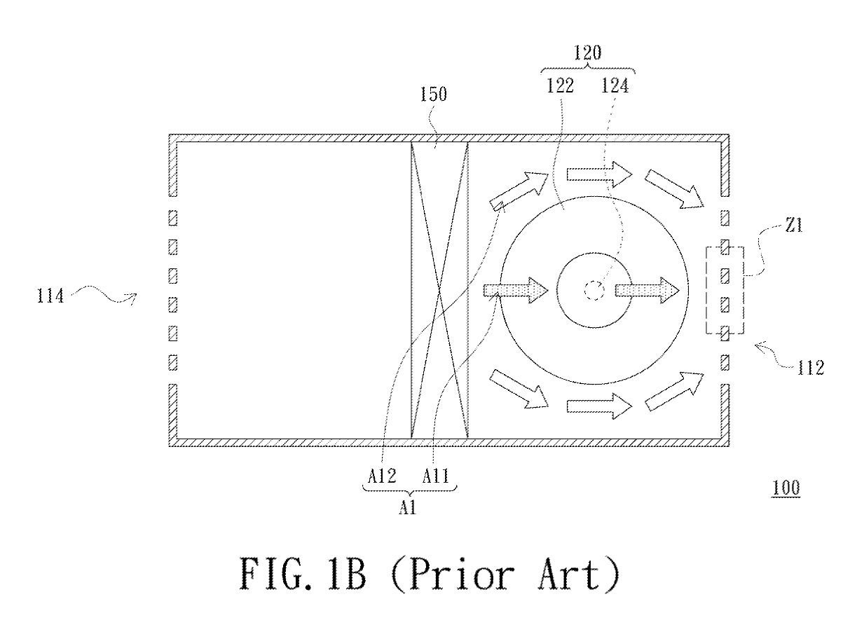

FIG. 2A is a schematic view of another traditional projector.

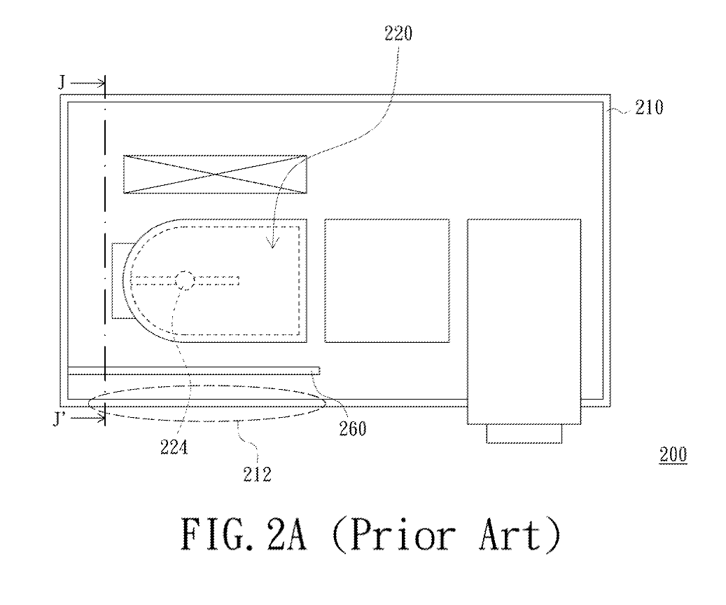

FIG. 2B is a cross-sectional schematic view of the projector of FIG. 2A taken along the line J-J′.

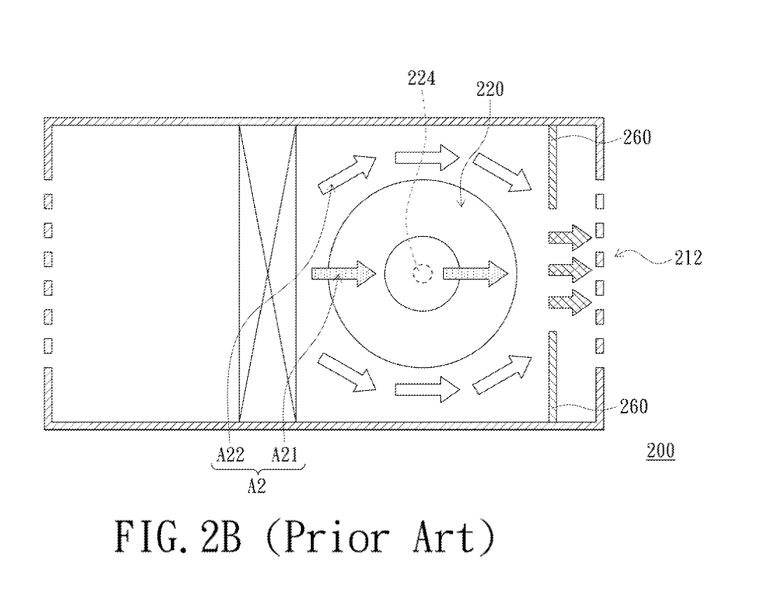

FIG. 3A is a schematic view of a projector of one embodiment of the invention.

FIG. 3B is a three-dimensional schematic view of a portion of the projector of FIG. 3A.

FIG. 3C is a cross-sectional schematic view of the projector of FIG. 3A taken along the line K-K′.

FIG. 4 is a three-dimensional schematic view of a portion of a projector of another embodiment of the invention.

FIG. 5 is a cross-sectional schematic view of a projector of another embodiment of the invention

### DETAILED DESCRIPTION

In the following detailed description of the preferred embodiments, reference is made to the accompanying drawings which form a part hereof, and in which is shown by way of illustration specific embodiments in which the invention may be practiced. In this regard, directional terminology, such as “top,” “bottom,” “front,” “back,” etc., is used with reference to the orientation of the Figure(s) being described. The components of the invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component facing “B” component directly or one or more additional components is between “A” component and “B” component. Also, the description of “A” component “adjacent to” “B” component herein may contain the situations that “A” component is directly “adjacent to” “B” component or one or more additional components is between “A” component and “B” component. Accordingly, the drawings and descriptions will be regarded as illustrative in nature and not as restrictive.

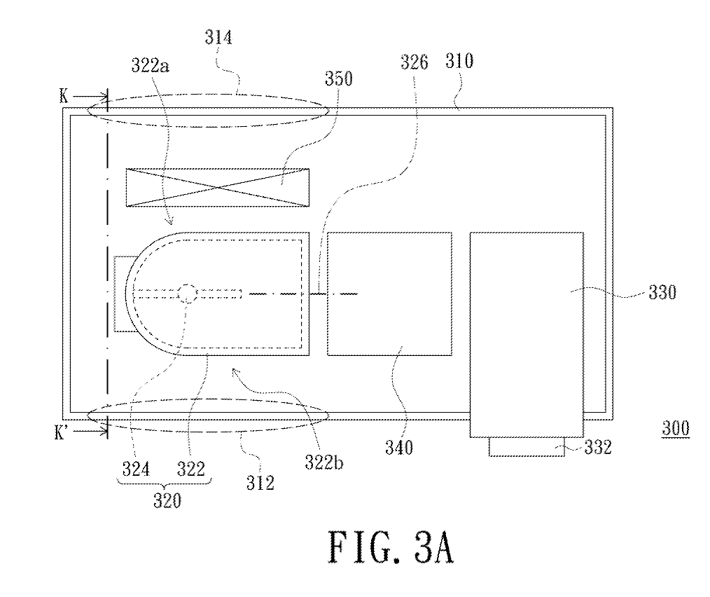

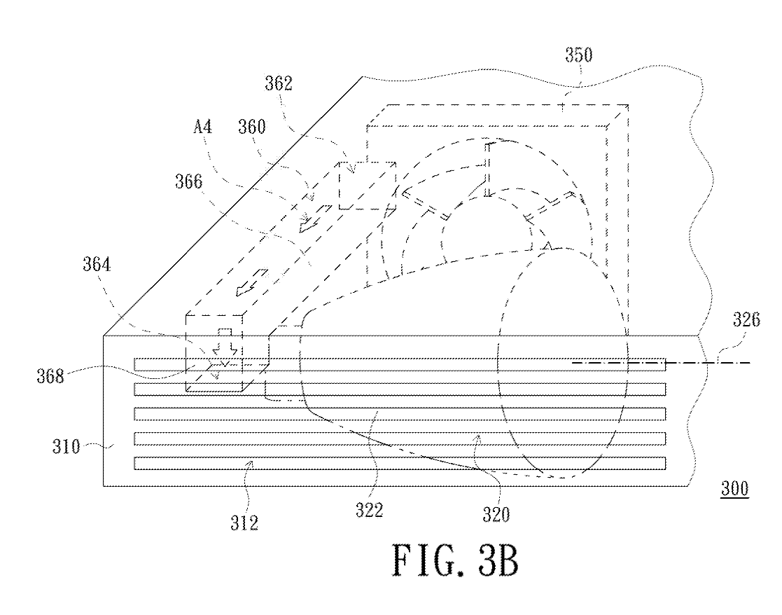

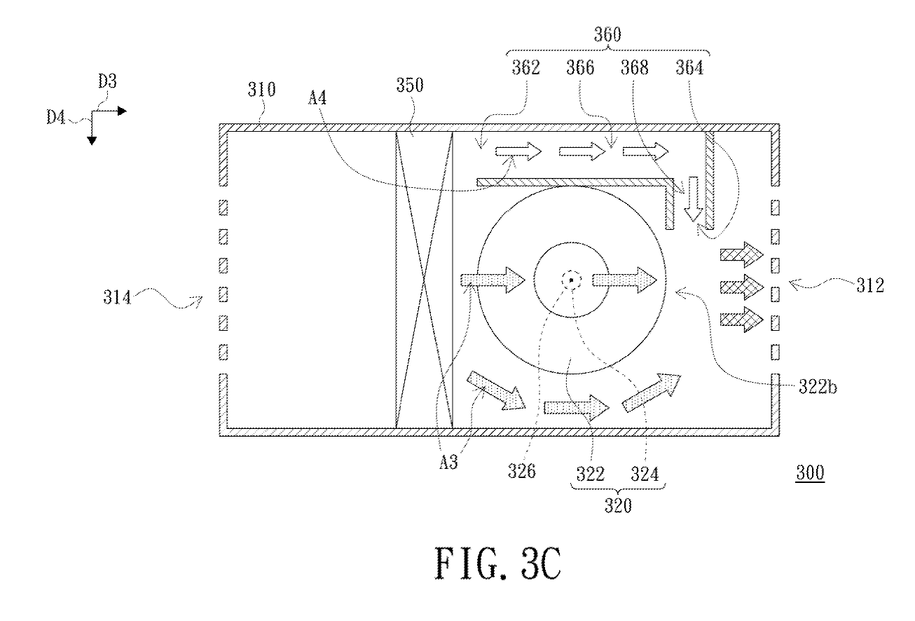

FIG. 3A is a schematic view of a projector of one embodiment of the invention. FIG. 3B is a three-dimensional schematic view of a portion of the projector of FIG. 3A. FIG. 3C is a cross-sectional schematic view of the projector of FIG. 3A taken along the line K-K′. It should be noted that for the convenience of description, a top portion of a housing and a guiding passage are not shown in FIG. 3A. Referring to FIGS. 3A, 3B and 3C, a projector 300 of the embodiment of the invention includes a housing 310, a light source 320, an imaging system 330, an optical system 340, a fan 350 and a guiding passage 360. The housing 310 has a main air outlet 312 and a main air inlet 314. The light source 320 is disposed in the housing 310 and located beside the main air outlet 312. The light source 320 includes a reflector 322 and a lampwick 324 disposed in the reflector 322. The lampwick 324 is capable of generating an illumination light beam.

The optical system 340 is disposed in the housing 310 and located in a transmission path of the illumination light beam. The optical system 340 is capable of converting the illumination light beam into an image light beam. The imaging system 330 is partially disposed in the housing 310 and located in a transmission path of the image light beam. The imaging system 330 includes a projection lens 332 which can project the image light beam onto a screen (not shown). The fan 350 is located beside the light source 320 and adjacently disposed beside a first side 322a of the reflector 322 of the light source 320.

The guiding passage 360 is disposed in the housing 310 and has a guiding inlet 362, a guiding outlet 364, a first guiding path 366 and a second guiding path 368. In the embodiment of the invention, the second guiding path 368 of the guiding passage 360 may be a tube-shaped body. The guiding passage 360 may be composed of a material with a thermal conductivity coefficient less than 20 W/mk. In addition, the first guiding path 366 extends beside the reflector 322 of the light source 320.

The guiding inlet 362 is disposed on one end of the first guiding path 366. The guiding inlet 362 is adjacently disposed beside the fan 350 and faces the fan 350. The second guiding path 368 connects with the first guiding path 366. The guiding outlet 364 is disposed on one end of the second guiding path 368 and adjacently disposed beside a second side 322b of the reflector 322 of the light source 320. In summary, the guiding passage 360 extends from a section near the fan 350 to a section near the second side 322b of the reflector 322 of the light source 320 such that the light source 320 is located between the fan 350 and the guiding outlet 364 and the guiding outlet 364 is located between the light source 320 and the main air outlet 312.

When the projector 300 operates, the fan 350 generates a first airflow A3 and a second airflow A4. The first airflow A3 flows through the reflector 322 and may flow the lampwick 324 of the light source 320. The second airflow A4 flows through the guiding passage 360 via the guiding inlet 362 and then flows out of the guiding outlet 364. The second airflow A4 in the guiding passage 360 is spatially spaced apart from the first airflow A3. The first airflow A3 is mixed with the second airflow A4 near the second side 322b of the reflector 322 of the light source 320.

The second airflow A4 is guided by the guiding passage 360 and forcibly mixed with the first airflow A3 near the second side 322b of the reflector 322 of the light source 320. Therefore, compared with the air mixture efficiency of the operating traditional projector 100, the air mixture efficiency of the first airflow A3 and the second airflow A4 is better when the projector 300 of the embodiment of the invention is operated such that the temperature near the main air outlet 312 is relatively low so as to meet a design specification requirement.

Additionally, since the second guiding path 368 of the guiding passage 360 may be the tube-shaped body with a small volume, the effect of flow resistance generated by the guiding passage 360 may not reduce the flow amount of the airflow A4 flowing through the main air outlet 312. Accordingly, compared with the guiding plates 260 of the traditional projector 200, the arrangement of the guiding passage 360 may not influence the transmission of the waste heat generated by the lampwick 324 of the light source 320 and therefore, the temperature near the lampwick 324 may be relatively low.

It should be pointed out that in the embodiment of the invention, a flowing direction D4 of the second airflow A4 near the guiding outlet 364 is substantially perpendicular to a flowing direction D3 of the first airflow A3. The flowing direction in the embodiment of the invention means an overall flowing tendency of the airflow. According to relative positions in FIG. 3C, the flowing direction D4 of the second airflow A4 near the guiding outlet 364 is downward and the flowing direction D3 of the first airflow A3 is from left to right. In addition, an optical axis 326 of the light source 320 is substantially perpendicular to the flowing direction D3 of the first airflow A3 and the flowing direction D4 of the second airflow A4.

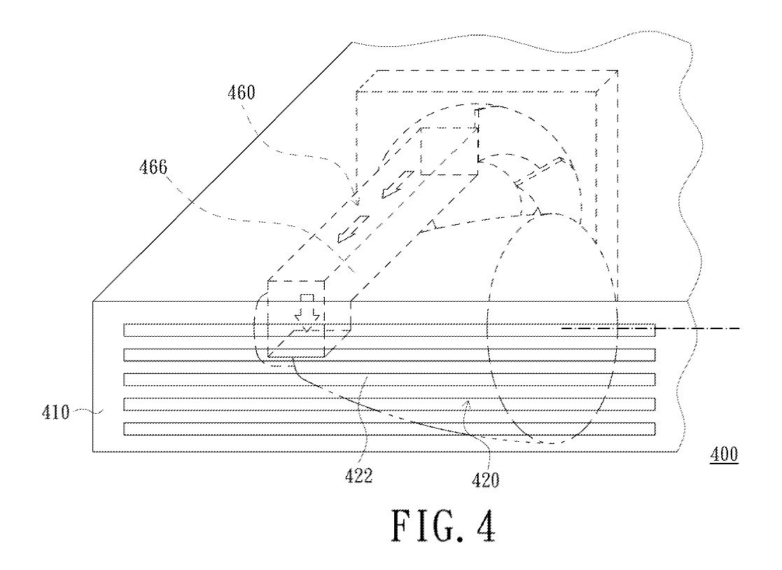

FIG. 4 is a three-dimensional schematic view of a portion of a projector of another embodiment of the invention. Referring to FIG. 4, the difference between a projector 400 of the embodiment of the invention and the projector 300 of the above embodiment of the invention is that a first guiding path 466 of a guiding passage 460 not only extends beside a light source 420 but also is located between a top portion of a housing 410 and a reflector 422 of the light source 420.

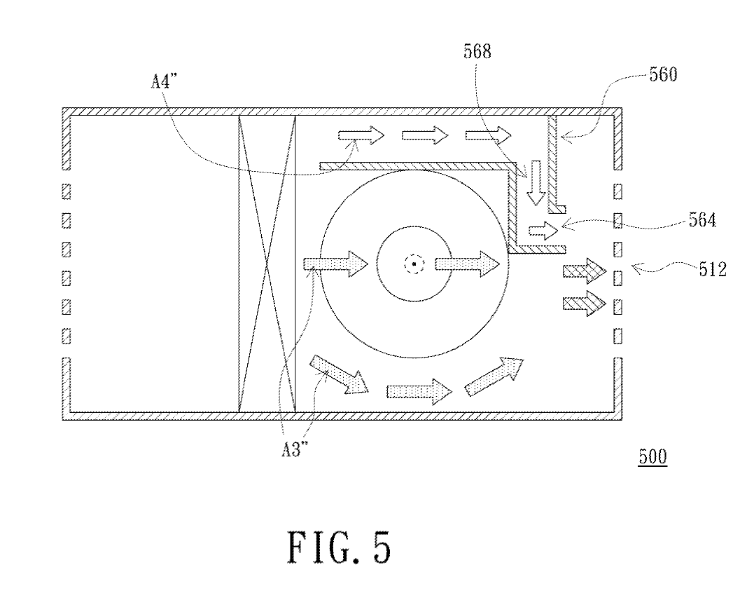

FIG. 5 is a cross-sectional schematic view of a projector of another embodiment of the invention. Referring to FIG. 5, the difference between a projector 500 of the embodiment of the invention and the projector 300 of the above embodiment of the invention is that a second guiding path 568 of a guiding passage 560 is L-shaped and a guiding outlet 564 faces a main air outlet 512 such that a flowing direction of a second airflow A4″ near the guiding outlet 564 is substantially parallel to a flowing direction of a first airflow A3″.

In summary, these embodiments of the invention include at least one of the following advantages.

1. Since the second airflow guided by the guiding passage is mixed with the first airflow near the second side of the light source, the mixture efficiency of the first airflow and the second airflow is better when the projector of the invention is operated.

2. Since the second guiding path of the guiding passage may be the tube-shaped body with a small volume, the effect of flow resistance generated by the guiding passage may not reduce the flow amount of the airflow flowing through the main air outlet. Accordingly, the arrangement of the guiding passage may not influence the transmission of the waste heat generated by the light source and therefore, the temperature near the light source may be relatively low.

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the disclosure is intended to be dedicated to the public regardless of whether the element or component is explicitly recited in the following claims.

What is claimed is:

1. A projector, comprising:
a light source;
a fan disposed beside a first side of the light source; and
a guiding passage having a guiding inlet and a guiding outlet, the guiding inlet being disposed beside the fan, the guiding outlet being disposed beside a second side of the light source, and the guiding passage extending from a section near the fan to a section near the second side of the light source such that the light source is located between the fan and the guiding outlet;
wherein the fan is capable of generating a first airflow and a second airflow, the first airflow is capable of flowing through the light source, the second airflow is capable of flowing through the guiding passage, the second airflow in the guiding passage is spatially spaced apart from the first airflow, and the first airflow is capable of being mixed with the second airflow near the second side of the light source.

2. The projector of claim 1, wherein the guiding passage further comprises a first guiding path and a second guiding path, the guiding inlet is disposed on one end of the first guiding path, the first guiding path extends beside the light source, the second guiding path connects with the first guiding path, and the guiding outlet is disposed on one end of the second guiding path.

3. The projector of claim 2, further comprising a housing, wherein the light source, the fan and the guiding passage are disposed in the housing, and the first guiding path is located between the housing and the light source.

4. The projector of claim 2, wherein the second guiding path is a tube-shaped body.

5. The projector of claim 1, wherein a flowing direction of the second airflow near the guiding outlet is substantially perpendicular to a flowing direction of the first airflow.

6. The projector of claim 1, wherein a flowing direction of the second airflow near the guiding outlet is substantially parallel to a flowing direction of the first airflow.

7. The projector of claim 1, wherein an optical axis of the light source is substantially perpendicular to a flowing direction of the first airflow and a flowing direction of the second airflow.

8. The projector of claim 1, wherein the guiding passage is composed of a material with a thermal conductivity coefficient less than 20 W/mk.
